(19) United States
(12) Patent Application Publication
(10) Pub. No.: US 2023/0267317 A1
(43) Pub. Date: Aug. 24, 2023

(54) SIGN-AWARE RECOMMENDATION APPARATUS AND METHOD USING GRAPH NEURAL NETWORK

(71) Applicant: INDUSTRY-ACADEMIC COOPERATION FOUNDATION, YONSEI UNIVERSITY, Seoul (KR)

(72) Inventors: Won Yong SHIN, Seoul (KR); Chang Won SEO, Yesan-gun (KR); Kyeong-Joong JEONG, Seoul (KR)

(21) Appl. No.: 18/054,073

(22) Filed: Nov. 9, 2022

(30) Foreign Application Priority Data
Nov. 12, 2021 (KR) 10-2021-0155724

(51) Int. Cl. G06N 3/048; G06N 3/084

(52) U.S. Cl. CPC G06N 3/048; G06N 3/084

(57) ABSTRACT

A recommendation apparatus separately extracts a positive graph and a negative graph representing the user's preference and non-preference for each item from the bipartite graph representing the relationship between users and items obtained using evaluation data, and vectorizes a plurality of nodes corresponding to users and items based on each of the extracted positive graph and negative graph and embeds them in a common virtual embedding space to recommend items that the user would prefer by considering not only preferences but also non-preferences of similar users for items.

### CROSS-REFERENCE TO RELATED APPLICATIONS

This application claims priority under 35 U.S.C. § 119(a) to Korean Patent Application No. 10-2021-0155724, filed on Nov. 12, 2021, in the Korean Intellectual Property Office, the disclosure of which is incorporated herein in its entirety by reference.

### BACKGROUND

### 1. Technical Field

The present disclosure relates to a recommendation apparatus and method, more particularly to a sign-aware recommendation apparatus and method using a graph neural network.

### 2. Description of the Related Art

Recommendation devices are widely used as a method of providing suitable recommendation solutions to customers in various fields such as e-commerce, advertisements, and social media sites. One of the well-known techniques in recommendation devices is Collaborative Filtering (CF) that determines similar users by calculating the degree of similarity between users and items based on the interaction history, and recommends items preferred by similar users, assuming that the determined similar users have similar preferences for items.

Meanwhile, recently, a recommendation device using a network embedding (NE) technique that models high-order connection information on user-item interaction as a vector in a low-dimensional virtual embedding space has been actively researched. A typical example of a network embedding technique is a graph neural network (hereinafter, GNN), which is an artificial neural network that vectorizes nodes in an embedding space based on a graph structure consisting of nodes corresponding to objects such as users and items and edges that are connected between nodes and represent relationships between connected nodes.

GNN receives a graph composed of nodes and edges, analyzes edges connecting nodes together with node information, vectorizes each node, and places them on an embedding space. And by exchanging messages with neighboring nodes through edges connected between nodes in the graph structure, the state of each node, that is, information about the node is updated to change the position of the vectorized and arranged nodes on the embedding space. GNN basically assumes that the target node and its neighbor nodes are similar to each other, and transmits and aggregates the information of the neighbor nodes connected with edges as a message so that the information of the target node is updated. GNN is an artificial neural network that exhibits very good performance in representing relationships between a plurality of objects, and is currently being applied to various recommendation devices.

However, various network embedding techniques, including existing GNN, basically vectorize nodes by considering only the user's preference for items, that is, positive interactions between nodes. Therefore, similar users are selected as users who have a common liking for similar items. Accordingly, although the user's non-preference can also provide a lot of information about interaction with an item, just like the preference, in previous network embedding techniques there is a limitation that the corresponding information could not be utilized because it was not configured to consider non-preference.

For example, information on the relationship between items such as various products or various media contents such as movies or music and the user is usually displayed in the form of an evaluation score ranging from 1 to 5 points. In these evaluation scores, a high score such as 4 or 5 indicates preference for the item, while a low score of 1 or 2 indicates non-preference. Nevertheless, as the evaluation scores themselves all have positive values, in existing embedding devices, all evaluation scores are considered as positive evaluations. Accordingly, a high evaluation score is considered as high preference, and a low evaluation score is considered only as low preference, and since a low evaluation score is not considered as a negative evaluation, that is, user's non-preference, much information is lost. In particular, although negative evaluation is information that is clearly different from irrelevance or indifference in which the user did not evaluate the item, in the past there was a limit in that negative evaluation and irrelevance are not separately reflected.

### SUMMARY

An object of the present disclosure is to provide a recommendation apparatus and method capable of accurately recommending an item suitable for a user in consideration of preferences and non-preferences according to user's positive and negative evaluations of the item.

A recommendation apparatus according to an embodiment of the present disclosure, conceived to achieve the objectives above, comprises a graph generating unit which, in a bipartite graph composed of a plurality of user nodes corresponding to each of a plurality of users, a plurality of item nodes corresponding to each of a plurality of items and a plurality of edges connecting the user nodes and the item nodes by weighting evaluation scores of a plurality of users for each item as a weight, is configured to classify and partition the plurality of edges into positive edges and negative edges according to the weight, and generate a positive graph having the positive edges and a negative graph having the negative edges; an embedding unit that is implemented as an artificial neural network, performs neural network operations according to a pre-trained method, vectorizes each of the positive graph and the negative graph to obtain a positive embedding vector and a negative embedding vector, and obtains a concatenation embedding vector in which the positive embedding vector and the negative embedding vector are concatenated, thereby determining positions of the plurality of user nodes and the plurality of item nodes in a virtual common embedding space; and a recommendation unit which recommends an item to each user based on a distance of each of the plurality of item nodes to each of the plurality of user nodes in the embedding space.

The embedding unit may include: a positive embedding part that receives the positive graph indicating preference of the plurality of users for the plurality of items, performs neural network operations according to a pre-trained method, and vectorizes each of the plurality of user nodes and the plurality of item nodes, thereby obtaining the positive embedding vector; a negative embedding part that receives the negative graph indicating non-preference of the plurality of users for the plurality of items, performs neural network operations according to a pre-trained method, and vectorizes each of the plurality of user nodes and the plurality of item nodes, thereby obtaining the negative embedding vector; and an integration emphasis embedding part that performs neural network operations according to a pre-trained method, estimates positive importance and negative importance corresponding to the positive embedding vector and the negative embedding vector, respectively, and weights the positive embedding vector and the negative embedding vector with the positive importance and the negative importance, thereby obtaining the concatenation embedding vector.

The positive embedding part may be implemented as a graph neural network (GNN), and the negative embedding part may be implemented as a multi-layer perceptron (MLP).

The graph generating unit may include: a signed graph acquisition part that determines whether a weight of each of a plurality of edges in the bipartite graph is greater than or equal to a predetermined reference weight, sets edges having a weight greater than or equal to a reference weight as the positive edges, and sets edges whose weight is less than the reference weight as the negative edges, thereby acquiring a signed graph including signed edges; and a partition graph acquisition part that partitions the signed graph into the positive graph composed of the plurality of user nodes, the plurality of item nodes and the positive edges, and the negative graph composed of the plurality of user nodes, the plurality of item nodes and the negative edges.

The graph generating unit may further include a bipartite graph acquisition part that receives evaluation data including evaluation scores evaluated on a plurality of items by the plurality of users, creates, from the evaluation data, a plurality of edges connecting user nodes and item nodes according to the plurality of user nodes corresponding to each of the plurality of users, the plurality of item nodes corresponding to the plurality of items and whether each user evaluated each item, and sets the evaluation scores as weights of the created edges, thereby acquiring the bipartite graph.

The recommendation apparatus may further include a sign-aware training unit provided during training and training the embedding unit implemented as an artificial neural network. The sign-aware training unit can acquire a plurality of batches by acquiring a plurality of triplet samples composed of related item nodes, which are item nodes connected by edges to each of a plurality of user nodes, and unrelated item nodes, which are item nodes that are not connected by edges, in a signed graph in which edges of the bipartite graph are signed with the positive edges and the negative edges, calculate a sign-aware loss as the sum of a sign-aware BPR loss calculated as a relationship in the common embedding space for the user nodes and, related item nodes and unrelated item nodes, respectively, according to the sign of the related item nodes in the acquired triplet samples, and a regularization loss according to regularization, and backpropagate the sign-aware loss.

A recommendation method according to another embodiment of the present disclosure, conceived to achieve the objectives above, comprises the steps of: in a bipartite graph composed of a plurality of user nodes corresponding to each of a plurality of users, a plurality of item nodes corresponding to each of a plurality of items and a plurality of edges connecting the user nodes and the item nodes by weighting with evaluation scores of a plurality of users for each item as a weight, classifying and partitioning the plurality of edges into positive edges and negative edges according to the weight, and generating a graph partitioned into a positive graph having the positive edges and a negative graph having the negative edges; obtaining positive embedding vectors and negative embedding vectors vectorized by performing a neural network operation on each of the positive graph and the negative graph using a pre-trained artificial neural network, and obtaining concatenation embedding vectors in which the positive embedding vectors and the negative embedding vectors are concatenated, thereby determining and embedding positions of the plurality of user nodes and the plurality of item nodes in a virtual common embedding space; and recommending an item to each user based on a distance of each of the plurality of item nodes to each of the plurality of user nodes in the embedding space.

Accordingly, the recommendation apparatus and method according to an embodiment of the present disclosure separately extracts a positive graph and a negative graph representing the user's preference and non-preference for each item from the bipartite graph representing the relationship between users and items obtained using evaluation data, and vectorizes a plurality of nodes corresponding to users and items based on each of the extracted positive graph and negative graph and embeds them in a common virtual embedding space, so that it is possible to accurately recommend items that the user would definitely prefer by considering not only preferences but also non-preferences of similar users for items.

### BRIEF DESCRIPTION OF THE DRAWINGS

FIG. 1 shows a schematic configuration of a sign-aware recommendation apparatus using a graph neural network according to an embodiment of the present disclosure.

FIG. 2 is a diagram for explaining a schematic operation according to each configuration of the sign-aware recommendation apparatus of FIG. 1.

FIG. 3 is a diagram for explaining detailed operations of the graph generating unit of FIG. 1.

FIG. 4 is a diagram for explaining in detail an operation of obtaining a positive embedding vector by the positive embedding part of FIG. 1.

FIG. 5 is a diagram for explaining a detailed operation of the sign-aware training unit of FIG. 1.

FIG. 6 shows a sign-aware recommendation method using a graph neural network according to an embodiment of the present disclosure.

### DETAILED DESCRIPTION

In order to fully understand the present disclosure, operational advantages of the present disclosure, and objects achieved by implementing the present disclosure, reference should be made to the accompanying drawings illustrating preferred embodiments of the present disclosure and to the contents described in the accompanying drawings.

Hereinafter, the present disclosure will be described in detail by describing preferred embodiments of the present disclosure with reference to accompanying drawings. However, the present disclosure can be implemented in various different forms and is not limited to the embodiments described herein. For a clearer understanding of the present disclosure, parts that are not of great relevance to the present disclosure have been omitted from the drawings, and like reference numerals in the drawings are used to represent like elements throughout the specification.

Throughout the specification, reference to a part “including” or “comprising” an element does not preclude the existence of one or more other elements and can mean other elements are further included, unless there is specific mention to the contrary. Also, terms such as “unit”, “device”, “module”, “block”, and the like described in the specification refer to units for processing at least one function or operation, which may be implemented by hardware, software, or a combination of hardware and software.

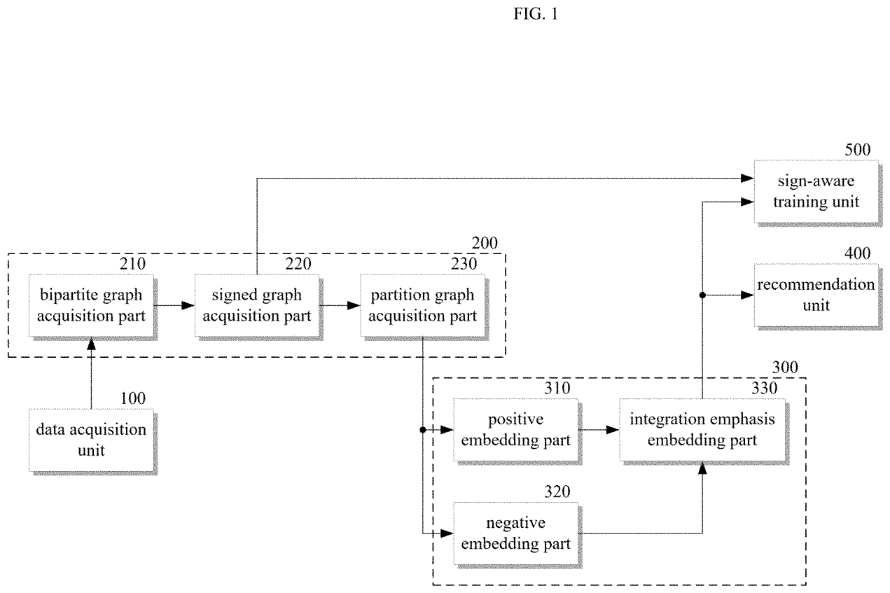

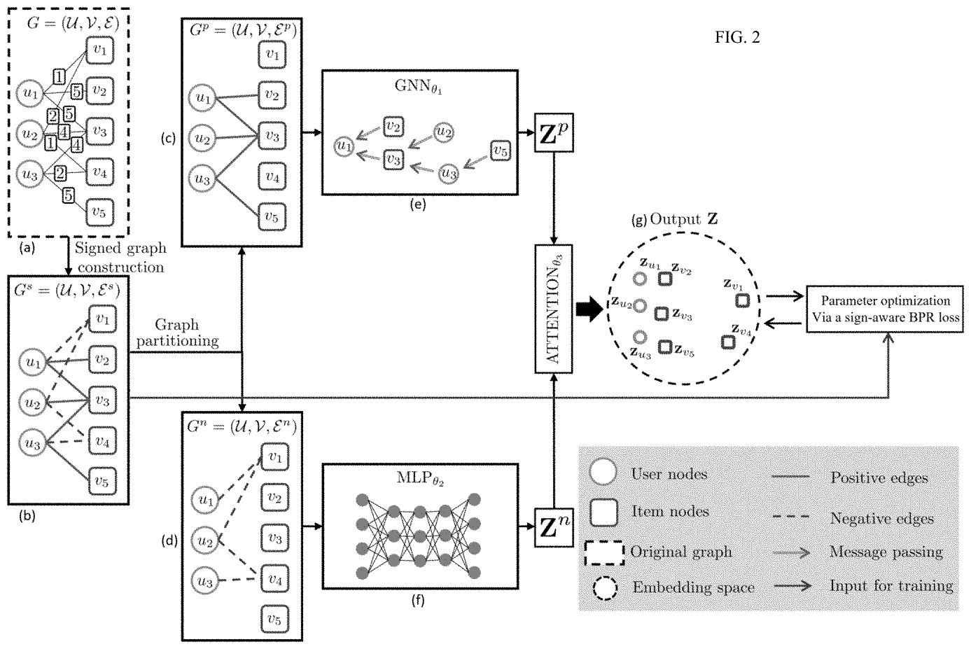

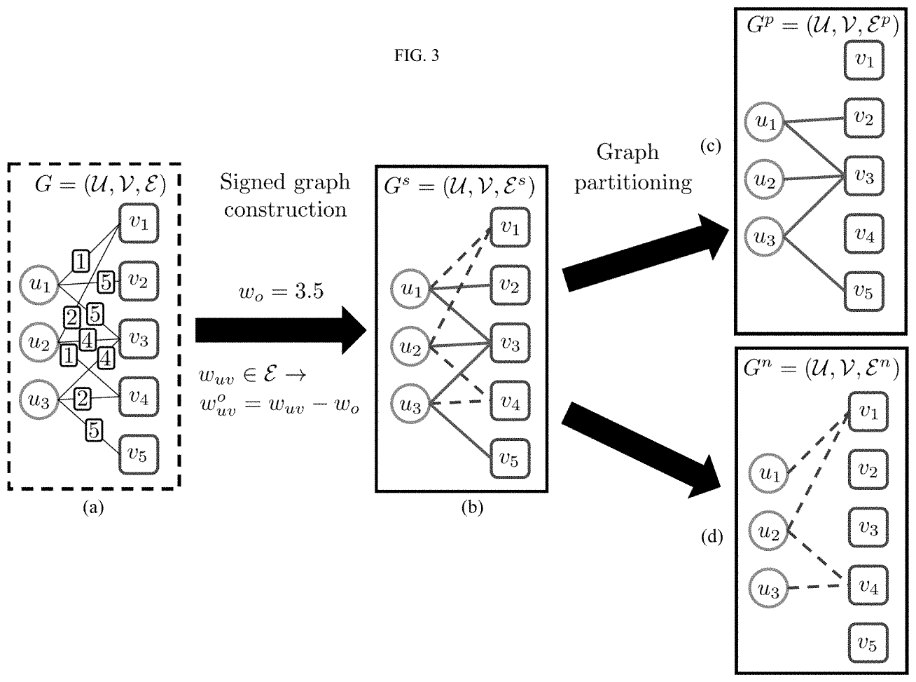

FIG. 1 shows a schematic configuration of a sign-aware recommendation apparatus using a graph neural network according to an embodiment of the present disclosure, FIG. 2 is a diagram for explaining a schematic operation according to each configuration of the sign-aware recommendation apparatus of FIG. 1, and FIG. 3 is a diagram for explaining detailed operations of the graph generating unit of FIG. 1.

Referring to FIG. 1, the sign-aware recommendation apparatus according to the present embodiment may include a data acquisition unit 100, a graph generating unit 200, an embedding unit 300 and a recommendation unit 400.

The data acquisition unit 100 may include user information for a plurality of users, item information for a plurality of items and evaluation information evaluated by each of a plurality of users for each of a plurality of items. Here, the evaluation information may consist of evaluation scores given by each user to each item. In the present embodiment, for convenience of understanding, it is assumed that the evaluation score can be assigned as a natural number within a predetermined range (here, 1 to 5 points as an example).

The graph generating unit 200 generates a relationship graph representing a relationship between a plurality of users and a plurality of items based on the evaluation data acquired by the data acquisition unit 100. In particular, in this embodiment, the graph generating unit 200 generates a positive graph (G^{p}) representing preference indicating a positive relationship between a plurality of users and a plurality of items, and a negative graph (Gⁿ) representing a non-preference indicating a negative relationship, as shown in (c) and (d) of FIGS. 2 and 3.

Specifically, the graph generating unit 200 may include a bipartite graph acquisition part 210, a signed graph acquisition part 220 and a partition graph acquisition part 230.

The bipartite graph acquisition part 210 generates a bipartite graph (G=(U, V, E)) composed of a user node group (U={uᵢ˜u_{M}}) including each of M users as a user node (u), an item node group (V={v₁˜v_{N}}) including each of the N items as an item node (v), and an edge group (E) including a plurality of edges representing the relationship between each user node (u) and each item node (v), connecting each user node (u) and each item node (v), from the evaluation data. Here, each of the plurality of edges has an evaluation score evaluated by each user for each item as a weight (wᵤᵥ).

In the bipartite graph (G=(U, V, E)), a plurality of edges cannot be configured to connect between user nodes (u) or between item nodes (v). In addition, when a specific user has not evaluate a specific item, the weight (wᵤᵥ) is set to 0, and an edge connecting the corresponding user node (u) and the corresponding item node (v) may be omitted.

As shown in (a) of FIGS. 2 and 3, the bipartite graph acquisition part 210 may acquire a bipartite graph (G=(U, V, E)) in the form of connecting a plurality of user nodes (u₁ to u₃) and a plurality of item nodes (v₁ to v₅) through a plurality of edges, and each edge has a weight (wᵤᵥ) according to the evaluation score. Here, since it is assumed that the evaluation score can be set only with natural numbers in the range of 1 to 5, it can be seen that the weight (wᵤᵥ) for each edge is given as a natural number in the range of 1 to 5, in (a) of FIGS. 2 and 3.

The signed graph acquisition part 220 determines whether the weight (wᵤᵥ) of each of the plurality of edges (wᵤᵥ) in the bipartite graph (G) generated in the bipartite graph acquisition part 210 is greater than or less than a predetermined reference weight (w₀), and encodes each of a plurality of edges. Here, the reference weight (w₀) is a reference value of evaluation scores set to distinguish the user's preference or non-preference for an item, and here, as an example, it is assumed that the reference weight (w₀) is set to the middle value (w₀=3.5) of the evaluation score range. However, the reference weight (w₀) may be set in various ways according to a user's evaluation method for an item and an evaluation score giving method. That is, the reference weight (w₀) may be set to an average value of evaluation scores for a plurality of items by a plurality of users, another predetermined statistical value, or the like.

The signed graph acquisition part 220 acquires a subtraction weight (w^{s}ᵤᵥ=wᵤᵥ−w₀) by subtracting the reference weight (w₀) from the weight (wᵤᵥ) assigned to each of the plurality of edges of the edge group (E) in the bipartite graph (G). Then, if the sign of the subtraction weight (w^{s}ᵤᵥ) is positive (w^{s}ᵤᵥ>0), that is, if the weight (wᵤᵥ) is greater than the reference weight (w₀), a positive sign (+) is assigned to the corresponding edge to set it as a positive edge, whereas, if the sign of the subtraction weight (w^{s}ᵤᵥ) is negative (w^{s}ᵤᵥ<0), that is, if the weight (wᵤᵥ) is smaller than the reference weight (w₀), a negative sign (−) is assigned to the corresponding edge to set it as a negative edge. Accordingly, by converting the edge group (E) into a signed edge group (E^{s}), a signed graph (G^{s}=(U, V, E^{s})) as shown in (b) of FIGS. 2 and 3 is obtained. In (b) of FIGS. 2 and 3, edges marked with a solid line represent positive edges, and edges marked with a dotted line represents negative edges.

That is, the signed graph acquisition part 220 encodes the edges, to which various weights (wᵤᵥ) representing in detail user's preference level for an item are assigned, as positive edges and negative edges, thereby acquiring the signed graph (G^{s}) simplified to indicate only the user's preference or non-preference for an item.

Here, since it is assumed that the weight (wᵤᵥ) is set to a natural number in the range of 1 to 5, and the reference weight (w₀) is set to the median value of 3.5, the case where the weight (wᵤᵥ) and reference weight (w₀) are the same cannot exist, so it is omitted. However, depending on how the weight (wᵤᵥ) and the reference weight (w₀) are set, there may be a case where the weight (wᵤᵥ) and the reference weight (w₀) are the same (wᵤᵥ=w₀). As such, when the weight (wᵤᵥ) and the reference weight (w₀) are the same, that is, when the subtraction weight (w^{s}ᵤᵥ) is 0 (w^{s}ᵤᵥ=0), it can be set to a positive edge or a negative edge according to a predetermined method.

The partition graph acquisition part 230 classifies the signed graph (G^{s}) acquired in the signed graph acquisition part 220 according to positive edges and negative edges, thereby acquiring by partitioning into two independent graphs of a positive graph (G^{p}) as shown in (c) of FIGS. 2 and 3 and a negative graph (Gⁿ) as shown in (d). Here, as shown in (c) and (d) of FIGS. 2 and 3, each of the positive graph (G^{p}) and the negative graph (Gⁿ) may be configured to include only one corresponding edge group (G^{p}=(U, V, E^{p}), Gⁿ=(U, V, Eⁿ)) from a positive edge group (E^{p}) consisting of only positive edges or a negative edge group (Eⁿ) consisting only of negative edges, while maintaining a plurality of nodes of the signed graph (G^{s}), that is, a user node group (U) and an item node group (V) including M user nodes (u) and N item nodes (v), as it is. In this way, when the signed graph (G^{s}) is partitioned into a positive graph (G^{p}) and a negative graph (Gⁿ) by the partition graph acquisition part 230, the positive graph (G^{p}) appears as a graph reflecting only the user's preference for an item, while the negative graph (Gⁿ) appears as a graph reflecting only the user's non-preference for the item. Accordingly, it is possible to separately distinguish and clearly check the preference and non-preference of each user for each item.

Accordingly, the graph generating unit 200 obtains a positive graph (G^{p}) representing preference indicating a positive relationship between a plurality of users and a plurality of items and a negative graph (Gⁿ) representing a non-preference indicating a negative relationship.

The embedding unit 300 vectorizes M user nodes (u) of the user node group (U) and N item nodes (v) of the item node group (V) using the positive graph (G^{p}) and the negative graph (Gⁿ) generated by the graph generating unit 200, and projects them into a common embedding space.

The embedding unit 300 may include a positive embedding part 310, a negative embedding part 320, and an integration emphasis embedding part 330 each implemented with a pretrained artificial neural network.

Here, the positive embedding part 310 receives the positive graph (G^{p}) and vectorizes each of the M user nodes (u) and N item nodes (v) of the positive graph (G^{p}) to obtain a positive embedding vector (Z^{p}), thereby embedding the positive graph (G^{p}) into a d-dimensional virtual positive embedding space. That is, each of the vectorized M user nodes (u) and N item nodes (v) is placed in the positive embedding space. Here, the positive embedding vector (Z^{p}) can be obtained with a size of Z^{p}ϵ [symbol] (M+N)×d.

Like the existing network embedding technique, the positive embedding part 310 embeds a plurality of nodes into the embedding space based on the positive edge group (E^{p}) of the positive graph (G^{p}) representing the user's positive preference for the item. That is, the positive embedding part 310 not only allows similar users to be located adjacent to each other and similar items to be located adjacent to each other in the embedding space as in the past, but also arranges users and items with a high relationship to be located close to each other. Accordingly, the positive embedding part 310 may use various artificial neural networks used in existing network embedding techniques.

Here, as an example, it is assumed that the positive embedding part 310 is implemented with a GNN, which is a representative artificial neural network used in the existing network embedding technique. Accordingly, since the operation of the positive embedding part 310 to obtain the positive embedding vector (Z^{p}) from the positive graph (G^{p}) is performed by the pre-learned neural network operation (GNN_{θ}_{₁}) of the GNN according to the GNN model parameter (θ₁) obtained by previous training, it can be expressed as in Equation 1.

Z^{P}=GNN_{θ}_{₁}(G^{p}) [Equation 1]

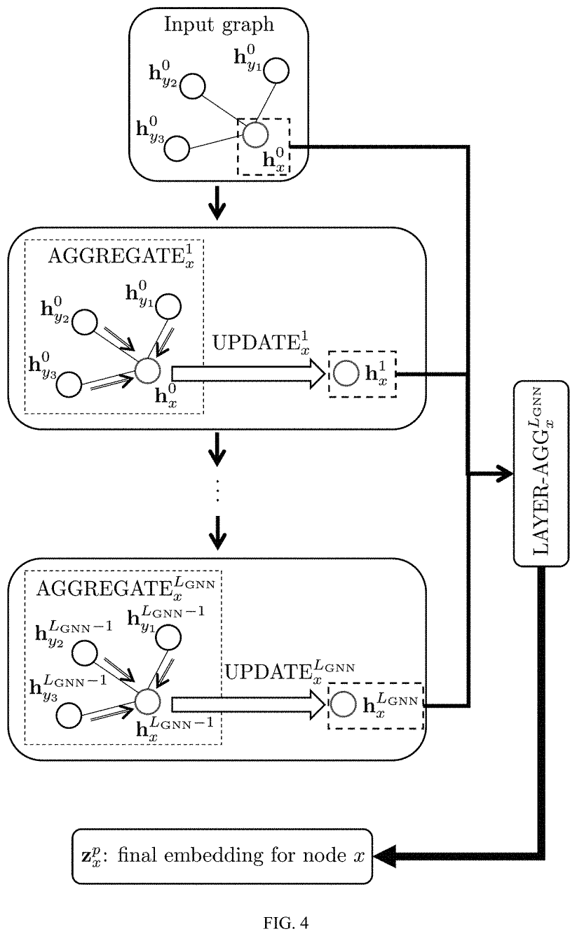

FIG. 4 is a diagram for explaining in detail an operation of obtaining a positive embedding vector by the positive embedding part of FIG. 1.

Specifically, since the positive embedding part 310 is implemented with a GNN, the positive embedding part 310 may use two functions called AGGREGATE and UPDATE according to the method of GNN to aggregate previously obtained potential embedding vectors (h_{y}¹⁻¹) for adjacent nodes (y) connected with an edge to a specific node (x), and may use the aggregated potential embedding vectors (h_{y}¹⁻¹) of the adjacent nodes (y) to obtain the positive embedding vector (Z^{p}) by using a message transmission method that repeats a process of updating the potential embedding vector (hₓ¹) of the node (x).

Referring to FIG. 4, in the GNN, in an lth GNN layer, the AGGREGATE function (AGGREGATE¹ₓ) aggregates the potential embedding vectors (h_{y}¹) of the neighboring nodes (y) of any node (x) of the positive graph (G^{p}) in the previous (1-1)th GNN layer, thereby obtaining aggregation information (mₓ¹). An operation of obtaining aggregation information from a neighboring node using the AGGREGATE function (AGGREGATE₁^{x}) can be expressed by Equation 2.

[symbol]

← [symbol] ({ [symbol] |yϵ [symbol] ∪{x}}) [Equation 2]

wherein [symbol] ϵ [symbol] represents [symbol] dimensional embedding vector for a node (x) in the (1-1)th GNN layer, Nₓ represents a set of adjacent nodes connected by edges to the node (x) in the positive graph (G^{p}), and [symbol] ϵ [symbol] represents the aggregation information for the node (x) in the lth GNN layer.

In Equation 2, since the node (x) belongs to the user node group (U) or the item node group (V), if the node (x) is a user node (u) belonging to the user node group (U), the AGGREGATE function (AGGREGATe¹ₓ) aggregates information of item nodes connected by edges among a plurality of item nodes (v) belonging to the item node group (V). Conversely, if the node (x) is an item node (v), information of user nodes (u) connected by edges are aggregated.

The AGGREGATE function (AGGREGATE¹ₓ) of Equation 2 can be obtained by Equation 3.

$${AGGREGATE}_{x}^{ℓ} = {\sum }_{y ∈ {N}_{x} ⋃ \{ x \}} \frac{1}{\sqrt{\vert {N}_{x} \vert + 1} \sqrt{\vert {N}_{y} \vert + 1}} {h}_{y}^{ℓ - 1} \qquad [ Equation 3 ]$$

In this embodiment, since the positive embedding part 310 simply uses a positive graph (G^{p}) in which a plurality of user nodes (u) and a plurality of item nodes (v) are connected by positive edges, any potential embedding vector (h⁰ₓ) can be set as an initial value.

In addition, the UPDATE function (UPDATE¹ₓ) updates the lth potential embedding vector (h¹ₓ) for the node (x) according to the aggregation information (m¹ₓ) aggregated for the node (x) in the lth GNN layer. An operation of obtaining the potential embedding vector (h¹ₓ) for the node (x) using the UPDATE function (UPDATE¹ₓ) can be expressed as Equation 4, and the UPDATE function (UPDATE¹ₓ) can be obtained as Equation 5.

[symbol]

← [symbol] (x, [symbol] ) [Equation 4]

[symbol]

= [symbol] · [symbol] [Equation 5]

wherein [symbol] ϵ [symbol] is a weight matrix determined by training in GNN, and is a GNN model parameter (θ₁).

In addition, since the potential embedding vectors (hₓ^{L}^{_{GNN}}) obtained in the last layer among a plurality of layers (1, . . . , L_{GNN}) tend to be over-smoothed, in order to alleviate this, aggregation layers (LAYER-AGGₓ^{L}^{_{GNN}}) are further added and potential embedding vectors (h⁰ₓ, . . . , hₓ^{L}^{_{GNN}}) obtained for each layer are aggregated to obtain positive embedding vectors (zₓ^{p}ϵ [symbol] ^{1×d}) for the node (x). An operation for the aggregation layers (LAYER-AGGₓ^{L}^{_{GNN}}) to obtain positive embedding vectors (zₓ^{p}) for each node (x) can be expressed by Equation 6.

zₓ^{p}←LAYER-AGGₓ^{L}^{_{GNN}}({ [symbol] ) [Equation 6]

In addition, the LAYER-AGGₓ^{L}^{_{GNN}} function in Equation 6 can be expressed as

Equation 7.

LAYER-AGGₓ^{L}^{_{GNN}}=hₓ⁰∥hₓ¹∥ . . . ∥hₓ^{L}^{_{GNN}} [Equation 7]

In Equation 7, ∥ represents a concatenation operator.

In some cases, the positive embedding part 310 may be implemented with the recently proposed LightGCN, so that the AGGREGATE function (AGGREGATE¹ₓ) and the UPDATE function (UPDATE¹ₓ) and function of Equations 3, 5 and 7 may be replaced with Equations 8 to 10, respectively.

$${AGGREGATE}_{x}^{ℓ} = {\sum }_{y ∈ {N}_{x}} \frac{1}{\sqrt{\vert {N}_{x} \vert} \sqrt{\vert {N}_{y} \vert}} {h}_{y}^{ℓ - 1} \qquad [ Equation 8 ]$$

$${UPDATE}_{x}^{ℓ} = {m}_{x}^{ℓ} \qquad [ Equation 9 ]$$

$$LAYER - {AGG}_{x}^{{L}_{GNN}} = \frac{1}{{L}_{GNN} + 1} {\sum }_{ℓ = 0}^{{L}_{GNN}} {h}_{x}^{ℓ} \qquad [ Equation 10 ]$$

However, as described above, the positive embedding part 310 of this embodiment may be implemented with various artificial neural networks based on existing GNNs, and may be configured to perform different operations according to applied neural networks.

Meanwhile, the negative embedding part 320 receives the negative graph (Gⁿ) and vectorizes each of M user nodes (u) and N item nodes (v) of the negative graph (Gⁿ) to obtain negative embedding vectors (Zⁿ). The negative embedding part 320 obtains each of the vectorized M user nodes (u) and N item nodes (v) and embeds them in a d-dimensional virtual negative embedding space. Here, the negative embedding vector (Zⁿ) may also be obtained with a size of Zⁿϵ [symbol] ^{(M+N)×d}.

Unlike the existing network embedding technique, the negative embedding part 320 embeds a plurality of nodes into the embedding space based on the negative edge group (Eⁿ) of the negative graph (Gⁿ) indicating non-preference, which is a user's negative evaluation for an item, so that, unlike the positive embedding part 310 in which similar users are located adjacent to each other and similar items are located adjacent to each other in the embedding space, users and items with low relationships should be located far from each other. Therefore, the artificial neural network used in the existing network embedding technique cannot be used in the negative graph (Gⁿ).

Accordingly, in this embodiment, for example, the negative embedding part 320 is composed of a multi-layer perceptron (hereinafter, MLP) to which the MLP model parameter (θ₂) obtained through training by deep learning is applied. An operation for the negative embedding part 320 to obtain the negative embedding vector (Zⁿ) from the negative graph (Gⁿ) is performed by the neural network operation (MLP_{θ}_{₂}) of the trained MLP, so it can be expressed as Equation 11.

Zⁿ=MLP_{θ}_{₂}(Gⁿ) [Equation 11]

Here, each layer (MLP₁) of the MLP may perform an operation according to a weight matrix (W_{MLP}¹) and a bias vector (b_{MLP}¹) obtained by training, and apply ReLU (Rectified Linear Unit) as an activation function to output a negative embedding vector (Z₁ⁿ) of each layer according to Equation 12.

[symbol]

=ReLU( [symbol] + [symbol] ) [Equation 12]

wherein, 1_{MLP}¹ is a vector of 1_{MLP}ϵ [symbol] ^{(M+N)×1} size with all elements equal to 1, and Z₀ⁿ is an arbitrary initial layer negative embedding vector.

In addition, as shown in Equation 13, the layer negative embedding vector (X_{L}_{_{MLP}}ⁿ) output from the final layer (L_{MLP}) is applied as the negative embedding vector (Zⁿ).

Zⁿ=Z_{L}_{_{MLP}}ⁿ [Equation 13]

Therefore, it can be seen that the weight matrix set ({ [symbol] ), the bias vector set ({ [symbol] ) and the initial layer negative embedding vector (Z₀ⁿ) correspond to the MLP model parameter (θ₂).

The integration emphasis embedding part 330 receives a positive embedding vector (Z^{p}) and a negative embedding vector (Zⁿ), and obtains a concatenation embedding vector (Z) by weighting the positive embedding vector (Z^{p}) and the negative embedding vector (Zⁿ) obtained by performing a neural network operation according to the pre-trained method with the corresponding importance (α^{p}, αⁿ: α^{p}, αⁿϵ [symbol] ^{(M+N)×1}), as shown in Equation 14, thereby embedding M user nodes and N item nodes in a common embedding space. That is, among nodes disposed in the positive embedding space and nodes disposed in the negative embedding space, nodes corresponding to each other are merged into a common embedding space.

Z=(α^{p}1ₐₜₜₙ)⊙Z^{p}+(αⁿ1ₐₜₜₙ)⊙Zⁿ

wherein, 1ₐₜₜ is a vector of 1ₐₜₜₙϵ [symbol] ^{1×d} size with all elements equal to 1.

In this embodiment, it is considered that the integration emphasis embedding part 330 composed of an artificial neural network obtains positive importance (α^{p}) and negative importance (αⁿ) by performing an attention extraction neural network operation (ATTENTION_{θ}_{₃}) performed based on the attention model parameters (θ₃) set by previous training, and this operation can be briefly expressed as Equation 15.

(α^{p},αⁿ)=ATTENTION_{θ}_{₃}(Z^{p},Zⁿ) [Equation 15]

If the attention values for the positive embedding vector (zₓ^{p}) and the negative embedding vector (zₓⁿ) for the node (x) are wₓ^{p} and wₓⁿ, respectively, the positive attention value (wₓ^{p}) and the negative attention value (wₓⁿ) can be expressed as Equations 16 and 17, respectively.

wₓ^{p}=q^{T} tanh(Wₐₜₜₙzₓ^{p}^{_{T}}+b) [Equation 16]

wₓⁿ=q^{T} tanh(Wₐₜₜₙzₓⁿ^{_{T}}+b) [Equation 17]

wherein, tanh(x) is a hyperbolic tangent activation function computed as

$$tanh ( x ) = \frac{exp ( x ) - exp ( - x )}{exp ( x ) + exp ( - x )} ,$$

and q, Wₐₜₜₙ, and b represent an attention vector, a weight matrix and a bias vector as attention model parameters (θ₃) of the integration emphasis embedding part 330 obtained by training, respectively.

The importance (α^{p}, αⁿ) can be obtained as shown in Equations 18 and 19 by applying the softmax function to the positive attentional values (wₓ^{p}) and negative attentional values (wₓⁿ) of Equations 16 and 17, respectively.

$${α}_{x}^{p} = \frac{exp ( {w}_{x}^{p} )}{exp ( {w}_{x}^{p} ) + exp ( {w}_{x}^{n} )} \qquad [ Equation 18 ]$$

$${α}_{x}^{n} = \frac{exp ( {w}_{x}^{n} )}{exp ( {w}_{x}^{p} ) + exp ( {w}_{x}^{n} )} \qquad [ Equation 19 ]$$

When the importance (α^{p}, αⁿ) are calculated by Equations 18 and 19, the concatenation embedding vector (Z) can be obtained according to Equation 14.

The embedding unit 300 may obtain an embedding vector (Z) representing a degree of similarity between users and items by considering both user's preferences and non-preferences for items using the positive graph (G^{p}) and negative graph (Gⁿ) obtained in the graph generating unit 200.

Here, in a common embedding space in which M user nodes and N items vectorized into a concatenation embedding vector (Z) are arranged, as shown in (g) of FIG. 2, users with similar characteristics are densely arranged, items with similar characteristics are densely arranged, and an item node corresponding to an item with high preference from each user is located adjacent to the corresponding user node, while an item node corresponding to an item with high non-preference is disposed far from the user node.

Accordingly, the recommendation unit 400 searches for a user node corresponding to a user to be recommended for an item in the common embedding space, and calculates the distance to N item nodes based on the searched user node, thereby recommending items corresponding to a predetermined number of item nodes to the user sequentially from item nodes placed in close proximity.

As a result, the recommendation apparatus according to the present embodiment selects a recommendation target considering not only user's preferences for a plurality of items, but also non-preferences, so that it can recommend an item suitable for a user more accurately than the existing recommendation apparatus that simply considers only preferences.

However, in order to actually use the recommendation apparatus according to the present embodiment, the positive embedding part 310, the negative embedding part 320 and the integration emphasis embedding part 330 of the embedding unit 300 implemented with an artificial neural network must be trained in advance. Accordingly, the recommendation apparatus of the present embodiment may further include a sign-aware training unit 500 for training the embedding unit 300. The sign-aware training unit 500 may be provided only during the training process, and may be removed after the training is completed.

In the present embodiment, the sign-aware training unit 500 performs training based on a sign-aware BPR loss that is a modification of the BPR (Bayesian personalized ranking) loss used for training also in the existing recommendation system.

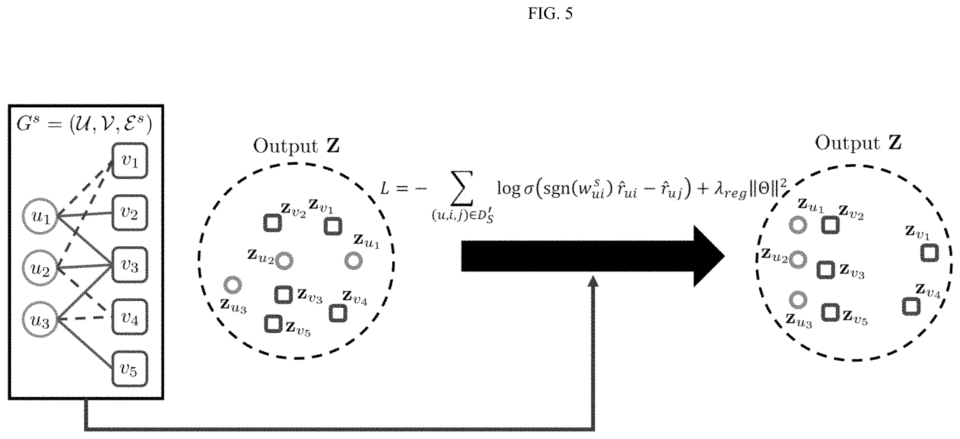

FIG. 5 is a diagram for explaining a detailed operation of the sign-aware training unit of FIG. 1.

The sign-aware training unit 500 must acquire a model parameter set (Θ={θ₁, θ₂, θ₃}) consisting of the GNN model parameter (θ₁), MLP model parameter (θ₂) and attention model parameter (θ₃) through training, and for this, the GNN model parameter (θ₁), MLP model parameter (θ₂) and attention model parameter (θ₃) of the model parameter set (Θ) are arbitrarily initialized.

In addition, a batch (Dₛ) composed of triplet samples (u, i, j) in the signed graph (G^{s}) is used as training data. The triplet sample (u, i, j) is a sample mainly used to calculate the BPR loss, and the triplet sample (u, i, j) consists of a related item node (iϵV) that is connected with the user node (uϵU) by an edge having a subtraction weight (wins) in the signed graph (G^{s}), and an unrelated item node (jϵV) that is not connected with the user node (u) by an edge. That is, regardless of the sign of the subtraction weight (w^{s}ᵤᵢ) of the edge connected to the user node (u), a batch (Dₛ) is obtained by acquiring a plurality of triplet samples (u, i, j) by checking related item nodes (i) connected through edges and determining unrelated item nodes (j) not connected by edges.

Specifically, the sign-aware training unit 500 determines item nodes connected with a user node (u) by edges in the signed graph (G^{s}), and acquires K unrelated item nodes (jₙ, n=1, K) that are not connected by edges, thereby creating a batch (Ds) including a plurality of triplet samples (u, i, j).

Here, the reason why the sign-aware training unit 500 creates a batch (Ds) including a plurality of triplet samples (u, i, j) is that it is necessary to distinguish between item nodes (i) connected with a user node (u) by edges and unconnected item nodes (j) regardless of the sign of the edges. In the present disclosure, even when the sign of the edge of the related item node (i) is negative, it is assumed that even an item node connected to the user node (u) by a negative edge should be placed closer to the user node (u) in the embedding space than an unrelated item node (j) not connected by an edge. This is because, even though an item node is connected by a negative edge indicating dislike, it has a clear relation to the user node (u), so it needs to be placed closer to the user node (u) than the unrelated item node (j) in the embedding space representing the relationship between the user and the item.

In addition, the predicted preference (\hat{r}ᵤᵢ) of the user node (u) for the related item node (i) in the triplet samples (u, i, j) of the batch (Ds) by the embedding unit 300 can be defined as in Equation 20, as an inner product of the user embedding vector (zᵤ) for the user node (u) in the embedding space and the related embedding vector (zᵢ) for the related item node (i).

\hat{r}ᵤᵢ [symbol] zᵤzᵢ^{T} [Equation 20]

In the same way, the predicted preference (\hat{r}ᵤᵢ) of the user node (u) for the unrelated item node (j) can also be calculated.

Meanwhile, in the present embodiment, in order to calculate the sign-aware BPR loss, a ternary relation (>ᵤ) of the triplet samples (u, i, j) is defined as in Equation 21.

>ᵤ(i,j,w) [symbol] {(i,j,w)|\hat{r}ᵤᵢ>\hat{r}ᵤⱼ if w>0 and −\hat{r}ᵤᵢ>\hat{r}ᵤⱼ otherwise} [Equation 21]

According to Equation 21, the ternary relation (>ᵤ) means that, when the weight (w) of an edge is greater than 0, the related predicted preference (\hat{r}ᵤᵢ) between the user node (u) and the related item node (i) is greater than the unrelated predicted preference (\hat{r}ᵤⱼ) between the user node (u) and the related item node (i), and when the weight (w) of an edge is not greater than 0, the negative related predicted preference (−\hat{r}ᵤᵢ) between the user node (u) and the related item node (i) is greater than the unrelated predicted preference (\hat{r}ᵤⱼ) between the user node (u) and the related item node (i).

If a ternary relation (>ᵤ) is defined as in Equation 21, the sign-aware BPR loss (L₀) is calculated according to Equation 22.

$${ℒ}_{0} = - {\sum }_{( u , i , j ) ∈ {D}_{s}^{′}} log p ( {>}_{u} ( i , j , {w}_{ui}^{s} ) \vert ⊖ ) \qquad [ Equation 22 ]$$

Here, p( ) is a function for obtaining a likelihood according to the ternary relation (>ᵤ), and is set as Equation 23.

p(>u(i,j,w^{s}ᵤᵢ)|Θ) [symbol] σ(sgn(w^{s}ᵤᵢ)\hat{r}ᵤᵢ−\hat{r}ᵤⱼ) [Equation 23]

wherein, sgn( ) is a sign function, and σ( ) is a sigmoid function calculated as

$$σ ( x ) = \frac{1}{1 + exp ( - x )} .$$

Finally, the sign-aware training unit 500 may calculate the sign-aware loss (L) according to Equation 24.

[symbol]

= [symbol] ₀+λ_{reg}∥Θ∥² [Equation 24]

wherein, ∥ ∥² is the L₂ regularization function, and λ_{reg} is a hyperparameter for adjusting the regularization strength.

That is, the sign-aware training unit 500 may calculate the sign-aware loss (L) as the sum of the sign-aware BPR loss (L₀) and the regularization loss (λ_{reg}∥Θ∥²) according to regularization.

Accordingly, as shown in FIG. 5, the sign-aware training unit 500 may train the positive embedding part 310, the negative embedding part 320 and the integration emphasis embedding part 330 of the embedding unit 300, by back-propagating to the embedding unit 300 the sign-aware loss (L) calculated in consideration of the sign-aware BPR loss (L₀) according to Equation 24 from the position where the user node (zᵤ) and item node (zᵥ) of the concatenation embedding vector (Z) obtained in the embedding unit 300 are disposed in the common embedding space. That is, the initialized GNN model parameter (θ₁), MLP model parameter (θ₂) and attention model parameter (θ₃) are repeatedly updated through training, so that the embedding unit 300 arranges the user node (zᵤ) and the item node (zᵥ) at appropriate positions in the common embedding space according to the relevance and irrelevance of preferences and non-preferences of a plurality of users for a plurality of items.

Referring to FIG. 5, it can be seen that, before the embedding unit 300 is trained, user nodes (zᵤ₁, zᵤ₂, Zᵤ₃) and item nodes (zᵥ₁ to zᵥ₅) were mixed and placed in a common embedding space, but after being trained, item nodes (zᵥ₂, zᵥ₃, zᵥ₅) connected with user nodes (zᵤ₁, zᵤ₂, zᵤ₃) by positive edges are placed adjacent to the user nodes (zᵤ₁, zᵤ₂, zᵤ₃), while item nodes (zᵥ₁, zᵥ₄) connected by negative edges are spaced apart from the user nodes (zᵤ₁, zᵤ₂, zᵤ₃). Although not shown in FIG. 5, if there are item nodes that are not connected by edges, the corresponding nodes may be disposed further away from the user nodes (zᵤ₁, zᵤ₂, zᵤ₃) than the item nodes (zᵥ₁, zᵥ₄) connected by negative edges.

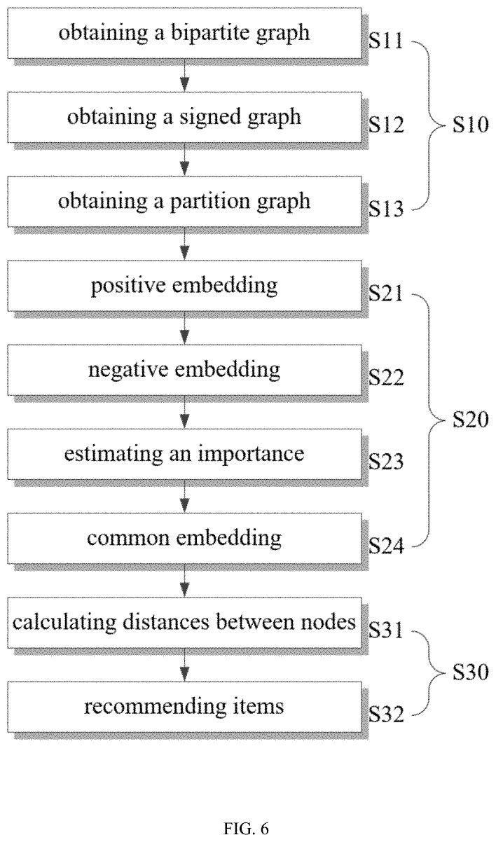

FIG. 6 shows a sign-aware recommendation method using a graph neural network according to an embodiment of the present disclosure.

Referring to FIGS. 1 to 5, the sign-aware recommendation method using a graph neural network according to the present embodiment may largely include a graph acquisition step (S10), an embedding step (S20) and a recommendation step (S30). In the graph acquisition step (S10), a positive graph (G^{p}) and a negative graph (Gⁿ) are obtained, each indicating preferences and non-preferences of a plurality of users for each of a plurality of items. Then, in the embedding step (S20), by performing neural network operations on the positive graph (G^{p}) and the negative graph (Gⁿ) using a pre-trained artificial neural network, a plurality of user nodes (u) corresponding to a plurality of users and a plurality of item nodes (v) corresponding to a plurality of items are arranged in a virtual common embedding space according to the trained method. Thereafter, in the recommendation step (S30), a predetermined N number of item nodes (v) are selected in an adjacent order according to the distance between each user node (u) and each item node (v) on the common embedding space, and the corresponding items are recommended to the user.

In the graph acquisition step (S10), first, a bipartite graph (G) representing a relationship between a plurality of users and a plurality of items is obtained (S11). Here, the bipartite graph (G) includes a plurality of user nodes (u) corresponding to each of a plurality of users, a plurality of item nodes (v) corresponding to each of a plurality of items, and a plurality of edges connecting the user nodes (u) and the item nodes (v) by weighting with evaluation scores of a plurality of users for each item as a weight (wᵤᵥ). If there is no evaluation score of a specific user for a specific item, the weight (wᵤᵥ) is set to 0, and an edge connecting the corresponding user node (u) and the corresponding item node (v) may be omitted.

In some cases, the bipartite graph (G) may be directly generated by obtaining evaluation data in which evaluation scores of a plurality of users for a plurality of items are recorded.

When the bipartite graph (G) is obtained, it is determined whether the weight (wᵤᵥ) of each of the plurality of edges (wᵤᵥ) is greater than or less than the predetermined reference weight (w₀), and the weight (wᵤᵥ) of each of the plurality of edges is signed as +(+1) or −(−1) to obtain a signed graph (G^{s}) having positive edges and negative edges (S12). Here, the reference weight (w₀) may be set to, for example, a median value (w₀=3.5) of the evaluation score range, but may also be set to other statistical values.

Then, the signed graph (G^{s}) is partitioned into two graphs, a positive graph (G^{p}) having only positive edges and a negative graph (Gⁿ) having only negative edges, according to the signed weight of each of the plurality of edges (S13). At this time, a plurality of user nodes (u) and a plurality of item nodes (v) are maintained.

Then, in the embedding step (S20), when two graphs of a positive graph (G^{p}) and a negative graph (Gⁿ) are obtained, using an artificial neural network trained to perform network embedding based on a graph such as GNN for the positive graph (G^{p}), a positive embedding vector (Z^{p}) is obtained by embedding a plurality of user nodes (u) and a plurality of item nodes (v) of the positive graph (G^{p}) in a virtual positive embedding space according to the preference relationship confirmed by the positive edges (S21).

Meanwhile, for the negative graph (Gⁿ), using a trained artificial neural network such as MLP, a negative embedding vector (Zⁿ) is obtained by embedding a plurality of user nodes (u) and a plurality of item nodes (v) of the negative graph (Gⁿ) in a virtual negative embedding space according to the non-preference relationship confirmed by the negative edges (S22). Here, for convenience of explanation, the negative embedding step (S22) is shown to be performed after the positive embedding step (S21) is performed, but the positive embedding step (S21) and the negative embedding step (S22) may be simultaneously performed in parallel.

Meanwhile, when the positive embedding vector (Z^{p}) and the negative embedding vector (Zⁿ) are obtained, using the trained artificial neural network, the importance (α^{p}, αⁿ) is estimated for each of the positive embedding vector (Z^{p}) and the negative embedding vector (Zⁿ) (S23). Then, by weighting the positive embedding vector (Z^{p}) and the negative embedding vector (Zⁿ), respectively, with the estimated importance (α^{p}, αⁿ) to obtain a concatenation embedding vector (Z), a plurality of user nodes (u) and a plurality of item nodes (v) are embedded in a common embedding space (S24).

Here, the positive embedding space, the negative embedding space, and the common embedding space are separately described, but the positive embedding space, the negative embedding space, and the common embedding space may all be the same embedding space.

In the subsequent recommendation step, distances between each of the plurality of user nodes (u) and the plurality of item nodes (v) are calculated in the common embedding space (S31). Then, for each of the plurality of user nodes (u), a predetermined N number of item nodes (v) are selected in an adjacent order, and N items according to the selected N item nodes (v) are recommended to the user corresponding to each user node (u) (S32).

Meanwhile, although not shown, in order to perform the embedding step, the artificial neural network must be trained in advance, and for this purpose, a training step may be further included. In the training step, a plurality of batches (Dₛ) are obtained by obtaining a plurality of triplet samples (u, i, j) consisting of related item nodes (i) connected to the user node (u) by edges, and unrelated item nodes (j) that is not connected in the signed graph (G^{s}), a sign-aware BPR loss (L₀) is calculated according to the ternary relation calculated as in Equation 21 in the common embedding space for the user nodes (u), the related item nodes (i), and the unrelated item nodes (j), respectively, according to the sign of the related item nodes (i) in the obtained triplet samples (u, i, j), and a sign-aware loss (L) is calculated and backpropagated as the sum of the sign-aware BPR loss (L₀) and the regularization loss (λ_{reg}∥Θ∥²) according to regularization, so that an artificial neural network can be trained.

A method according to the present disclosure can be implemented as a computer program stored in a medium for execution on a computer. Here, the computer-readable medium can be an arbitrary medium available for access by a computer, where examples can include all types of computer storage media. Examples of a computer storage medium can include volatile and non-volatile, detachable and non-detachable media implemented based on an arbitrary method or technology for storing information such as computer-readable instructions, data structures, program modules, or other data, and can include ROM (read-only memory), RAM (random access memory), CD-ROM's, DVD-ROM's, magnetic tapes, floppy disks, optical data storage devices, etc.

While the present disclosure is described with reference to embodiments illustrated in the drawings, these are provided as examples only, and the person having ordinary skill in the art would understand that many variations and other equivalent embodiments can be derived from the embodiments described herein.

Therefore, the true technical scope of the present disclosure is to be defined by the technical spirit set forth in the appended scope of claims.

What is claimed is:

1. A recommendation apparatus comprising:
a graph generating unit which, in a bipartite graph composed of a plurality of user nodes corresponding to each of a plurality of users, a plurality of item nodes corresponding to each of a plurality of items and a plurality of edges connecting the user nodes and the item nodes by weighting evaluation scores of the plurality of users for each item as a weight, is configured to classify and partition the plurality of edges into positive edges and negative edges according to the weight, and generate a positive graph having the positive edges and a negative graph having the negative edges;
an embedding unit that is implemented as an artificial neural network, performs neural network operations according to a pre-trained method, vectorizes each of the positive graph and the negative graph to obtain a positive embedding vector and a negative embedding vector, obtains a concatenation embedding vector in which the positive embedding vector and the negative embedding vector are concatenated, and thereby determines positions of the plurality of user nodes and the plurality of item nodes in a virtual common embedding space; and
a recommendation unit which recommends an item to each user based on a distance of each of the plurality of item nodes to each of the plurality of user nodes in the embedding space.

2. The recommendation apparatus according to claim 1,
wherein the embedding unit includes:
a positive embedding part that receives the positive graph indicating preference of the plurality of users for the plurality of items, performs neural network operations according to a pre-trained method, and vectorizes each of the plurality of user nodes and the plurality of item nodes, thereby obtains the positive embedding vector;
a negative embedding part that receives the negative graph indicating non-preference of the plurality of users for the plurality of items, performs neural network operations according to a pre-trained method, and vectorizes each of the plurality of user nodes and the plurality of item nodes, thereby obtains the negative embedding vector; and
an integration emphasis embedding part that performs neural network operations according to a pre-trained method, estimates positive importance and negative importance corresponding to the positive embedding vector and the negative embedding vector, respectively, and weights the positive embedding vector and the negative embedding vector with the positive importance and the negative importance, thereby obtains the concatenation embedding vector.

3. The recommendation apparatus according to claim 2,
wherein the positive embedding part is implemented as a graph neural network (GNN), and
the negative embedding part is implemented as a multi-layer perceptron (MLP).

4. The recommendation apparatus according to claim 1,
wherein the graph generating unit includes:
a signed graph acquisition part that determines whether a weight of each of a plurality of edges in the bipartite graph is greater than or equal to a predetermined reference weight, sets edges having a weight greater than or equal to a reference weight as the positive edges, and sets edges whose weight is less than the reference weight as the negative edges, thereby acquires a signed graph including signed edges; and
a partition graph acquisition part that partitions the signed graph into the positive graph composed of the plurality of user nodes, the plurality of item nodes and the positive edges, and the negative graph composed of the plurality of user nodes, the plurality of item nodes and the negative edges.

5. The recommendation apparatus according to claim 4,
wherein the reference weight is set to the median value of the evaluation scores of the plurality of users for each item.

6. The recommendation apparatus according to claim 4,
wherein the graph generating unit further includes
a bipartite graph acquisition part that receives evaluation data including evaluation scores evaluated on a plurality of items by the plurality of users, creates, from the evaluation data, a plurality of edges connecting user nodes and item nodes according to the plurality of user nodes corresponding to each of the plurality of users, the plurality of item nodes corresponding to the plurality of items and whether each user evaluated each item, and sets the evaluation scores as weights of the created edges, thereby acquires the bipartite graph.

7. The recommendation apparatus according to claim 2,
wherein the recommendation apparatus further includes
a sign-aware training unit provided during training the embedding unit implemented as an artificial neural network, and
wherein the sign-aware training unit acquires a plurality of batches by acquiring a plurality of triplet samples composed of related item nodes, which are item nodes connected by edges to each of a plurality of user nodes, and unrelated item nodes, which are item nodes that are not connected by edges, in a signed graph in which edges of the bipartite graph are signed with the positive edges and the negative edges, calculates a sign-aware loss as the sum of a sign-aware Bayesian personalized ranking (BPR) loss calculated as a relationship in the common embedding space for the user nodes and, related item nodes and unrelated item nodes, respectively, according to the sign of the related item nodes in the acquired triplet samples, and a regularization loss according to regularization, and backpropagates the sign-aware loss.

8. The recommendation apparatus according to claim 7,
wherein the sign-aware training unit
calculates a predicted preference (\hat{r}ᵤᵢ, \hat{r}ᵤⱼ) for each of the related item node (i) and the unrelated item node (j) of the user node (u) in the triplet sample (u, i, j) by, in the concatenation embedding vector, an inner product between a user embedding vector (zᵤ) corresponding to the user node (u) and a related embedding vector (zᵢ) for the related item node (i) and an inner product between the user embedding vector (zᵤ) and an unrelated embedding vector (zⱼ) for the unrelated item node (j), and
according to the sign of the weight (w) of the edge connecting the user node (u) and the related item node (i), based on a ternary relation (>ᵤ) defined by
>ᵤ(i,j,w) [symbol] {(i,j,w)|\hat{r}ᵤᵢ>\hat{r}ᵤⱼ if w>0 and −\hat{r}ᵤᵢ>\hat{r}ᵤⱼ otherwise} Equation
calculates a likelihood (p( )) according to the ternary relation (>ᵤ) by Equation
p(>u(i,j,w^{s}ᵤᵢ)|Θ) [symbol] σ(sgn(w^{s}ᵤᵢ)\hat{r}ᵤᵢ−\hat{r}ᵤⱼ)
(wherein, sgn( ) is a sign function, σ( ) is a sigmoid function calculated as
$$σ ( x ) = \frac{1}{1 + exp ( - x )} .$$
Θ is a model parameter set obtained by training in the positive embedding part, the negative embedding part and the integration emphasis embedding part implemented by an artificial neural network),
thereby calculates the sign-aware BPR loss according to Equation
$${ℒ}_{0} = - {\sum }_{( u , i , j ) ∈ {D}_{s}^{′}} log p ( {>}_{u} ( i , j , {w}_{ui}^{s} ) \vert ⊖ ) .$$

9. The recommendation apparatus according to claim 8,
wherein the sign-aware training unit obtains the sign-aware loss according to [symbol]
= [symbol] ₀+λ_{reg}∥Θ∥²
(wherein, ∥ ∥² is the L₂ regularization function, and λ_{reg} is a hyperparameter for adjusting the regularization strength)
and backpropagates the sign-aware loss.

10. The recommendation apparatus according to claim 1,
wherein the recommendation unit calculates a distance between each of the plurality of user nodes and a plurality of item nodes in the common embedding space, selects a predetermined number of item nodes in an adjacent order for each of the plurality of user nodes, and recommends items to each user.

11. A recommendation method of a recommendation apparatus that performs an operation of recommending an item to a user, the method comprising the steps of:
in a bipartite graph composed of a plurality of user nodes corresponding to each of a plurality of users, a plurality of item nodes corresponding to each of a plurality of items and a plurality of edges connecting the user nodes and the item nodes by weighting with evaluation scores of a plurality of users for each item as a weight, classifying and partitioning the plurality of edges into positive edges and negative edges according to the weight, and generating a graph partitioned into a positive graph having the positive edges and a negative graph having the negative edges;
obtaining positive embedding vectors and negative embedding vectors vectorized by performing a neural network operation on each of the positive graph and the negative graph using a pre-trained artificial neural network, and obtaining concatenation embedding vectors in which the positive embedding vectors and the negative embedding vectors are concatenated, thereby determining and embedding positions of the plurality of user nodes and the plurality of item nodes in a virtual common embedding space; and
recommending an item to each user based on a distance of each of the plurality of item nodes to each of the plurality of user nodes in the embedding space.

12. The recommendation method according to claim 11,
wherein the embedding includes the steps of:
obtaining the positive embedding vector, by receiving the positive graph indicating preference of the plurality of users for the plurality of items, performing neural network operations according to a pre-trained method, and vectorizing each of the plurality of user nodes and the plurality of item nodes;
obtaining the negative embedding vector, by receiving the negative graph indicating non-preference of the plurality of users for the plurality of items, performing neural network operations according to a pre-trained method, and vectorizing each of the plurality of user nodes and the plurality of item nodes; and
obtaining the concatenation embedding vector, by performing neural network operations according to a pre-trained method, estimating positive importance and negative importance corresponding to the positive embedding vector and the negative embedding vector, respectively, and weighting the positive embedding vector and the negative embedding vector with the positive importance and the negative importance.

13. The recommendation method according to claim 12,
wherein the step of obtaining the positive embedding vector is implemented using a graph neural network (GNN), and
the step of obtaining negative embedding vector is implemented using a multi-layer perceptron (MLP).

14. The recommendation method according to claim 11,
wherein the generating the partitioned graph includes the steps of:
acquiring a signed graph including signed edges, by determining whether a weight of each of a plurality of edges in the bipartite graph is greater than or equal to a predetermined reference weight, setting edges having a weight greater than or equal to a reference weight as the positive edges, and setting edges whose weight is less than the reference weight as the negative edges; and
partitioning the signed graph into the positive graph composed of the plurality of user nodes, the plurality of item nodes and the positive edges, and the negative graph composed of the plurality of user nodes, the plurality of item nodes and the negative edges.

15. The recommendation method according to claim 14,
wherein the reference weight is set to the median value of the evaluation scores of the plurality of users for each item.

16. The recommendation method according to claim 14,
wherein the generating the partitioned graph further includes the step of,
prior to the step of acquiring the signed graph, acquiring the bipartite graph, by receiving evaluation data including evaluation scores evaluated on a plurality of items by the plurality of users,
creating, from the evaluation data, a plurality of edges connecting user nodes and item nodes according to the plurality of user nodes corresponding to each of the plurality of users, the plurality of item nodes corresponding to the plurality of items and whether each user evaluated each item, and setting the evaluation scores as weights of the created edges.

17. The recommendation method according to claim 12,
wherein the recommendation method further includes the step of training the artificial neural network, and
the step of training includes the steps of:
acquiring a plurality of batches by acquiring a plurality of triplet samples composed of related item nodes, which are item nodes connected by edges to each of a plurality of user nodes, and unrelated item nodes, which are item nodes that are not connected by edges, in a signed graph in which edges of the bipartite graph are signed with the positive edges and the negative edges; and
calculating a sign-aware loss as the sum of a sign-aware BPR loss calculated as a relationship in the common embedding space for the user nodes and, related item nodes and unrelated item nodes, respectively, according to the sign of the related item nodes in the acquired triplet samples, and a regularization loss according to regularization.

18. The recommendation method according to claim 17,
wherein the step of calculating a sign-aware loss includes the steps of:
calculating a predicted preference (\hat{r}ᵤᵢ, \hat{r}ᵤⱼ) for each of the related item node (i) and the unrelated item node (j) of the user node (u) in the triplet sample (u, i, j) by, in the concatenation embedding vector, an inner product between a user embedding vector (zᵤ) corresponding to the user node (u) and a related embedding vector (zᵢ) for the related item node (i) and an inner product between the user embedding vector (zᵤ) and an unrelated embedding vector (zⱼ) for the unrelated item node (j), and
according to the sign of the weight (w) of the edge connecting the user node (u) and the related item node (i), based on a ternary relation (>ᵤ) defined by
>ᵤ(i,j,w) [symbol] {(i,j,w)|\hat{r}ᵤᵢ>\hat{r}ᵤⱼ if w>0 and −\hat{r}ᵤᵢ>\hat{r}ᵤⱼ otherwise}
calculating a likelihood (p( )) according to the ternary relation (>ᵤ) by Equation
p(>u(i,j,w^{s}ᵤᵢ)|Θ) [symbol] σ(sgn(w^{s}ᵤᵢ)\hat{r}ᵤᵢ−\hat{r}ᵤⱼ)
(wherein, sgn( ) is a sign function, σ( ) is a sigmoid function calculated as
$$σ ( x ) = \frac{1}{1 + exp ( - x )} .$$
Θ is a model parameter set obtained by training in a positive embedding part, a negative embedding part and an integration emphasis embedding part implemented by an artificial neural network),
thereby calculating the sign-aware BPR loss according to Equation
$${ℒ}_{0} = - {\sum }_{( u , i , j ) ∈ {D}_{s}^{′}} log p ( {>}_{u} ( i , j , {w}_{ui}^{s} ) \vert ⊖ ) ;$$
and
obtaining the sign-aware loss according to Equation [symbol]
= [symbol] ₀+λ_{reg}∥Θ∥²
(wherein, ∥ ∥² is the L₂ regularization function, and λ_{reg} is a hyperparameter for adjusting the regularization strength)
and backpropagating the sign-aware loss.

19. The recommendation method according to claim 11,
wherein the step of recommending an item includes the steps of:
calculating a distance between each of the plurality of user nodes and a plurality of item nodes in the common embedding space; and
selecting a predetermined number of item nodes in an adjacent order for each of the plurality of user nodes, thereby recommending items to each user.
